(19) United States
(12) Patent Application Publication
(10) Pub. No.: US 2018/0357028 A1
(43) Pub. Date: Dec. 13, 2018

(54) MANUALLY ACTUATED HAND TOOL

(71) Applicant: WEZAG GmbH Werkzeugfabrik, Stadtallendorf (DE)

(72) Inventor: Thomas Glockseisen, Duesseldorf (DE)

(21) Appl. No.: 15/981,121

(22) Filed: May 16, 2018

(30) Foreign Application Priority Data
Jun. 9, 2017 (EP) 17 175 202.5

(51) Int. Cl. G06F 3/147; B25B 7/06; B25G 1/10

(52) U.S. Cl. CPC G06F 3/147; B25B 15/02; B25G 1/10; B25B 7/06

(57) ABSTRACT

The invention relates to a manually actuated hand tool (2) which might e.g. be embodied as pliers (1). According to the invention, the hand tool (2) comprises a display device (13) by which it is possible to display a hand tool identification (16). It is possible to electrically modify the displayed hand tool identification (16). It is possible to permanently display the hand tool identification (16) without electric powering. Preferably, for this purpose the display device (13) comprises a so-called “electronic paper”.

### CROSS REFERENCE TO RELATED APPLICATIONS

This application claims priority to co-pending European Patent Application No. EP 17 175 202.5 filed on Jun. 6, 2017.

### FIELD OF THE INVENTION

The invention relates to a manually actuated hand tool for which a tool force applied by the hand tool upon a workpiece is not generated by an external force (e.g. of an electric drive, a hydraulic drive or a pneumatic drive) but manually by a user. The manually actuated hand tool is e.g. a screw driver or embodied as pliers (in particular stripping pliers, crimping pliers, pressing pliers, tube pressing pliers, pressing pliers for fittings or cutting pliers).

### BACKGROUND OF THE INVENTION

For manually actuated hand tools an identification of the hand tool with a hand tool identification might be of interest. In order to mention only some non-limiting examples, an individual hand tool identification of the hand tool might be the name of the user or of the owner of the hand tool in order to allow or simplify an allocation of the hand tool to this user or owner. The use of an individual hand tool identification embodied as a sequence of ciphers or a number might also be used e.g. for a documentation of the hand tool individualized in this way with respect to its date of purchase, the purchased batch, the uses of the hand tool, the frequency of the uses of the hand tool and the duration of the operation of the hand tool. Furthermore, it is possible that a plurality of hand tools is equipped with the same hand tool identification which e.g. indicates the manufacturing company of the hand tool or the company of the industrial customer where the hand tool is used. It is also possible that a hand tool identification indicates a type of the hand tool, a configuration of the hand tool and the like.

Hand tool identifications are usually provided by tags or labels at the hand tool. It is also possible that a hand tool is identified by a colored design of an outer surface of the hand tool. Here, it is possible that the outer surface is printed or an elastomeric handle of the hand tool is produced in a multi-step injection molding process (cp. DE 697 30 318 T2, corresponding to EP 0 888 204 B1). Finally, an individual identification of the hand tools is also in particular provided by the craftsmen by purposefully equipping the outer surface of the hand tool with a chamfering, scratch or lettering.

WO 2011/156918 A2 discloses a load cell which can be arranged between a tool for generating an actuation torque and a mounting element comprising a thread. By means of the load cell it is possible to sense the actuation torque generated by the tool and being applied to the mounting element. The load cell comprises a sensor for sensing the actuation torque, an electronic control unit for processing the measurement signal and a display controlled by the electronic control unit. By means of the display, the presently applied actuation torque, a present actuation angle and the actuation torque generated during the process and measured at the end and the corresponding actuation angle are displayed. For the display preferably an electronic paper is used.

DE 20 2009 002 062 U1 (corresponding to US 2009/0255386 A1) discloses a torque socket nut having no electronically modifiable display device.

US 2014/0165796 A1 does not relate to a manually actuated hand tool but to a tool machine held by hand with an integrated drive supplied by an accumulator with power. The tool machine further comprises an electronic control unit which controls a display device comprising three LEDs in order to display operating parameters, in particular an actuation torque of the tool machine. It is possible that for this purpose the LEDs have different colors, wherein then the LEDs are controlled dependent on the present level of the actuation torque. The display device might also comprise an LCD display at which then the absolute value of the actual actuation torque is displayed. The display might also be provided by display bars. Here, the heights of the display bars correspond to the absolute value of the actuation torque. The display might also display a numeric value of the actuation torque.

WO 2015/110212 A1 discloses a tool machine held by hand. An electric drive of the tool machine is supplied via a cable with power. The tool machine might e.g. be an angle grinder. The tool machine comprises an electronic display unit which might base upon LEDs, an LCD display, an OLED display or an electronic paper. Here, the display is able to display letter, graphics, symbols, pictograms, pictures, films and the like wherein also a touch-sensitive display might be used. In this way, at the display device an operating parameter of the tool machine is displayed. By means of the display device it is possible to display to the user an optimal operating region, an overload, the need for service, a chosen operating modus as an energy saving modus, a stand-by-modus, an operating parameter as a number of revolutions or a torque. The display might also transmit information to the user by a slow or fast flashing, a constant illumination, a change of the light intensity or a color.

DE 298 06 179 U1 discloses crimping pliers wherein by force sensors a force in a pliers mouth and the extent of the opening of the mouth is measured. A handle shell of the crimping pliers comprises an input device with keys. By the keys the user of the crimping pliers is able to transmit information to an electronic control unit of the crimping pliers. A handle of the crimping pliers comprises a sending and receiving element with a bi-directional infrared interface. Finally, at the upper side of the crimping pliers a signal output device comprising a liquid crystal display is arranged. Optionally, DE 298 06 179 U1 proposes that the crimping pliers comprise an interface for a plug for the connection to a galvanic or optical cable. Also the use of a cable port RS 232 is possible or the use of photo-transistors for a wireless data transfer. Additional to the liquid crystal display also light-emitting diodes having different colors might be provided at the crimping pliers. Dependent on the control of one of two light-emitting diodes it is possible to signal to the user of the crimping pliers if during a crimping process an error has occurred or the crimping process has not passed according to the specifications.

DE 10 2004 009 489 A1 discloses crimping pliers comprising an LCD display. By the LCD display information is displayed to the user for making adjustments of the crimping pliers.

The national publication DE 10 2015 122 572 A1 which has not been published prior to the present application discloses a surgical hand tool wherein the actuation torque can be limited in a plurality of steps by a plurality of torque-limiting elements. The surgical hand tool comprises a display device by which it is possible to display to the user the number of remaining torque-limiting steps. Here, the display device might be embodied as LED, backlit display unit, matrix display unit, LCD display, OLED display or electronic paper.

### SUMMARY OF THE INVENTION

The invention bases on the object to propose a manually actuated hand tool which is improved with respect to the provision of a hand tool identification.

The invention proposes to equip the manually actuated hand tool with a display device. The display device does not produce a permanent hand tool identification as being the case for the scratching, lettering, the production of a hand tool identification in a multi-step injection molding process, the tag and the like as described above. Instead, it is possible to modify the hand tool identification which can be displayed with the display device used according to the invention. A modification of the hand tool identification of this type might e.g. be used by the manufacturer in order to equip the hand tool with a trademark of the manufacturer, with an identification of the type or with a configuration or already with a hand tool identification requested by the customer. However, it is also possible that the display of the display device is modified by the customer or user or craftsman, e.g. in order to equip the hand tool with a hand tool identification embodied as a running number, a name of the user and the like.

According to the invention, it is notably simple to modify the display because according to the invention a display device is used which can be electrically modified.

Here, according to the invention, not any electric modifiable display device is used (as e.g. a display device formed with lamps or diodes or a classical screen). The reason is that the invention has recognized that complex display devices of this type are not suitable for a manually actuated hand tool in particular due to the mechanical biases being effective during the operation, due to the costs and due to a required permanent power supply for the operation of the display device. Instead, the invention proposes to use a display device for the hand tool which despite of the options of electrically modifying the hand tool identification permanently displays the hand tool identification without any electric powering of the display device being required. A display of this type should be permanently possible without any electric powering which means that without the use of any power source it is possible to display the hand tool identification at least for days, weeks, months or years.

Within the frame of the invention, as a display device in particular a technology can be used which is also denoted as “electronic paper”, E-Paper“, E-Papier”, “ePaper” or also “E-Ink”, and/or a display device can be used which generates a display of the hand tool identification on the basis of an electrophoresis. In order to mention a non-limiting example, micro-capsules (in particular with an average diameter in the range of 40 μm) can be used which contain positively loaded white particles and negatively loaded black particles in a transparent semifluid polymer. The short application of an electric voltage generates a selective orientation of the white and black particles which then remains stable also without an electric voltage at least for weeks. As a carrier material it is e.g. possible to use flexible plastic or glass. A control of picture elements or pixels can be provided by segment displays by means of passive transparent electrodes or for the use of a matrix display by use of a TFT-active-matrix. It is also possible to display levels of grey by a control of the progression in time of the applied voltage or by the use of colored display devices basing on electrophoresis. Electronic papers basing on electrophoresis are e.g. manufactured by the companies E Ink Corporation, Sipix, Plastic Logic, Goangzhou OED Technologies, Bridgestone, Philips. Also possible is the use of an electronic paper on the basis of bi-stable LCDs, an electronic paper basing on electro-moistening or a so-called “electro-wetting” where a colored oil level and a water level are placed one above the other and where the light translucence of single picture elements or pixels can be influenced by changing the surface voltage by an applied electric voltage, or electronic papers which base on a micro-mechanically controlled interference-modulation. With the frame of the invention, for the first time the generally known technology of an electronic paper is used for an in particular passive manually actuated hand tool. Accordingly, within the frame of the invention this technology is transferred from machine tools actuated by external power (e.g. according to the publications DE 10 2013 216 678 A1, DE 2013 217 911 A1, DE 10 2014 201 435 A1 (corresponding to US 2015/0209950 A1), DE 10 2014 201 436 A1 (corresponding to U.S. Pat. No. 9,868,200 B2), DE 20 2015 005 519 U1, US 2014/0166324 A1, US 2016/0223312 A1, US 2016/0318165 A1, DE 10 2004 050 240 B4), where an “electrification” is already present and where an electronic paper is used for a display of a measurement signal, a machine state or a loading state of an accumulator, a display of operating parameters, to the technological field of a passive (in particular not “electrified”) manually actuated hand tool.

The hand tool identification which is displayed by the display device might be a sequence of letters, numbers or ciphers. Preferably, the hand tool identification displayed by the display device is a user name and/or a sequence of ciphers individualizing the hand tool.

The display device might be positioned at any position of the surface of the hand tool being visibly from the outside or also in an interior space of the hand tool which might e.g. be covered by a flap, a lid or a slider. It is also possible that the display device is provided at a force-transferring component in the force flow between a manual actuation surface of the hand tool and a working surface of the hand tool which interacts with the workpiece which is processed by the hand tool. For a particular embodiment of the invention, the display device is arranged in the region of a manual actuation surface of the hand tool. The manual actuation surface of the hand tool might e.g. be formed by an elastomeric handle in the region of which then the display device can be arranged. The display device can e.g. be covered by injection molding by a plastic material of a handle of the hand tool or might be embedded into the same.

The invention might be used for any manually actuated hand tool. For one embodiment of the invention, the hand tool is a screw driver. In this case, the display device is preferably arranged in the region of the handle of the screw driver which might be the case in the region of the outer circumferential surface of the handle or also in the region of the front surface of the handle facing away from the blade of the screw driver.

For another proposal of the invention, the hand tool is formed by pliers, in particular stripping pliers, crimping pliers, pressing pliers, tube pressing pliers or pliers for fittings or cutting pliers. Pliers of this type comprise two hand levers which can be pivoted relative to each other. The user produces actuation forces at the hand levers. The actuation forces can then be transferred to pliers jaws by a drive mechanism (in some cases with an increasing or decreasing transmission ratio).

For the embodiment of the hand tool as pliers the display device can e.g. be arranged in the region of a hand lever. It is also possible that the display device is arranged in the region of a pliers head of the pliers. Here, the display of the display device might extend in the pliers head plane. In this case, it is e.g. possible that the display device is carried by a cover plate of the pliers in the region of the pliers head. However, it is also possible that the display plane of the display device extends such that a surface normal of the display plane is within the pliers head plane. In this case it is possible that the display device is arranged in the region of front faces of the cover plates of the pliers head. The display device might also at least partially be integrated into an intermediate space between the two cover plates. In the case that the display device is arranged in the region of a hand lever and the hand levers can be pivoted relative to each other in a pivot plane, the display plane might have an orientation parallel to the pivot plane. If then the pliers with the hand levers are lying on a support, the display plane of the display device is freely visible so that also the hand lever identification is visible. However, it is also possible that the display device is arranged on a side of a hand lever which faces towards the other hand lever or faces away from the same. It is possible that in this case a surface normal of the display plane of the display device extends parallel to the pivot plane of the hand levers.

In some cases a control unit, an electric cable and/or a port might be required for the operation of the display device and in particular the electric modification of the display of the same. Whereas it is generally possible that these electric components are arranged at any position of the hand tool, one embodiment of the invention proposes that the control unit, the electric cable and/or the port are/is integrated into a hand lever. In order to mention only a non-limiting example, a port (in particular a USB port) can be integrated into a front side of the hand lever which faces away from the pliers head. This port can then be connected by an electric cable to a control unit integrated into the interior of the hand lever and from there to the display device. If then a display of the display device is to be generated or modified, it is possible to connect the port to an external device by which then an electric power supply of the control unit and the display device can be provided in order to generate the display or modify the display and/or it is possible to transmit a control signal via the port which includes the hand tool identification which is to be generated or which is a new modified hand tool identification.

For a particular proposal, the hand lever comprises two metallic struts, in particular supporting legs, which are e.g. formed by a U-profile extending in longitudinal direction of the hand lever or by two plates held at a distance which also extend in longitudinal direction of the hand lever. In this case, the control unit, the electric cable and/or the port can be arranged between the two metallic struts of the hand lever. In this way, a protection of these in some cases sensitive electric components by the metallic supporting legs of the hand lever can be provided. Here, it is also possible that the struts form a channel, a recess or a bore through which an electrical cable is passed from an interior space of the supporting leg to the outside (or vice versa), e.g. to the port and/or the display device. It is possible that the two metallic struts serve for transmitting the actuation force and the struts are covered by an elastomeric plastic material for forming a handle of the hand lever.

Generally, the constructive design and the used technological principle for producing the display of the display device is arbitrary as long as the constructive design considers the mechanical biases being effective at the hand tool. For one proposal of the invention, the display device comprises a cover. By the cover the display device can be protective against mechanical biases. Cumulatively or alternatively, it is possible that by the cover a sealing of the display device is provided.

The hand tool preferably does not comprise a permanent power supply. In order to still be able to modify the display of the display device, accordingly an external power supply is required. Furthermore, preferably a selection or an input of a hand tool identification which is to be displayed at the display device is not provided by a selection field or input field of the hand tool. In order to still be able to supply power and provide an input, the invention for one embodiment proposes that the hand tool comprises a wireless receiving device by which an external power supply and/or the transmission of a control signal for generating or modifying a display of the display device can be provided. The wireless receiving device might e.g. be a RFID receiving device wherein the electrical power supply is provided by use of an external excitation frequency and by which also the receipt of a control signal is possible.

For another proposal if the invention, the hand tool comprises an interface, in particular a port or a plug. By the interface a wired external power supply can be provided and/or the transmission of a wired control signal for generating or modifying a display of the display device can be provided.

Advantageous developments of the invention result from the claims, the description and the drawings. The advantages of features and of combinations of a plurality of features mentioned at the beginning of the description only serve as examples and may be used alternatively or cumulatively without the necessity of embodiments according to the invention having to obtain these advantages. Without changing the scope of protection as defined by the enclosed claims, the following applies with respect to the disclosure of the original application and the patent: further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims.

The number of the features mentioned in the claims and in the description is to be understood to cover this exact number and a greater number than the mentioned number without having to explicitly use the adverb “at least”. For example, if a display device is mentioned, this is to be understood such that there is exactly one display device or there are two display devices or more display devices. Additional features may be added to these features, or these features may be the only features of the respective product.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with respect to preferred exemplary embodiments illustrated in the drawings.

FIG. 1 shows a manually actuated hand tool embodied as pliers in a three-dimensional view.

FIG. 2 shows a hand lever of the pliers of FIG. 1 in a longitudinal sectional view.

FIG. 3 shows the hand lever of FIG. 2 in a three-dimensional, partially sectional view.

FIGS. 4 to 7 show different embodiments of hand tools embodied as pliers with different locations for the arrangement of a display device.

FIG. 8 in a three-dimensional view shows a hand tool which is embodied as tube pressing pliers or plier for pressing of fittings.

FIG. 9 shows a detail IX of the hand tool of FIG. 8.

FIG. 10 shows a hand tool embodied as cutting pliers in a three-dimensional view.

FIG. 11 shows a detail XI of the cutting pliers of FIG. 10.

FIG. 12 shows a hand tool embodied as screw driver in a three-dimensional view.

### DETAILED DESCRIPTION

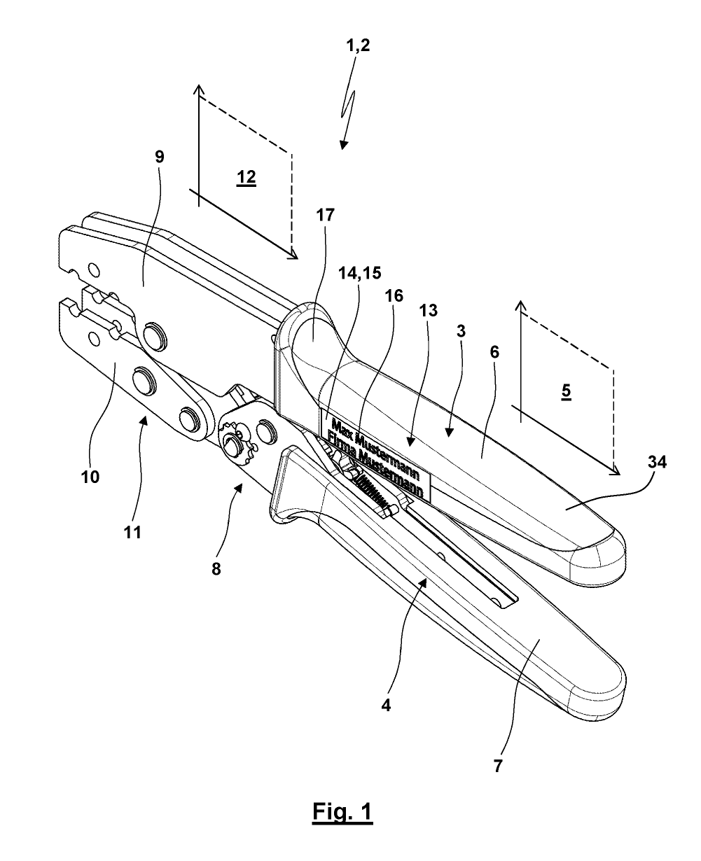

FIG. 1 shows a hand tool 2 embodied as pliers 1. The pliers 1 are crimping pliers here and e.g. generally designed according to the publications DE 197 53 436 C2, DE 198 02 287 C1 (corresponding to U.S. Pat. No. 6,054,025 A) or EP 2 305 428 A1 (corresponding to U.S. Pat. No. 8,516,872 B2) of the applicant or current products with the label “CK 100” of the applicant so that concerning the constructive design generally reference is made to these publications and products.

The pliers 1 comprise two hand levers 3, 4. The hand levers 3, 4 can be pivoted relative to each other in a pivot plane 5. The pivoting is provided by application of manual actuation forces by the user upon actuation surfaces 34 of handles 6, 7 of the hand levers 3, 4. The movement of the hand levers 3, 4 and the actuation forces manually applied thereupon are transmitted by a drive mechanism 8 (in particular with a toggle lever drive) with a suitable increasing or decreasing gear ratio to pliers jaws 9, 10. The pliers jaws 9, 10 form dies or carry dies (here not shown). Between the dies a workpiece to be processed is crimped (e.g. a plug is crimped to a cable). The plier jaws 9, 10 are arranged in the region of a pliers head 11. A pivoting of the pliers jaws 9, 10 is provided in a pliers head plane 12 or parallel to the same. The pivot plane 5 of the hand levers 3, 4 and the pliers head plane 12 are arranged parallel to each other or correspond to each other. A display device 13 is embedded into the handle 6 of the lever 3. A display 14 which comprises a here plane display area 15 displays a hand tool identification 16. The display area 15 might for a modified embodiment also be curved or bended and might e.g. adapt the contour of the handle 6. For the shown embodiment, the hand tool identification 16 is a lettering “Max Mustermann, Firma Mustermann”. According to FIG. 1, the surface normal of the display area 15 has an orientation vertical to the pivot plane 5. Accordingly, the display area 15 is arranged at a side surface of the handle 6 of the hand lever 3. The display area 15 is located in the front half of the handle facing towards the pliers head 11, the display area 15 being located behind a thickening 17 of the handle 6.

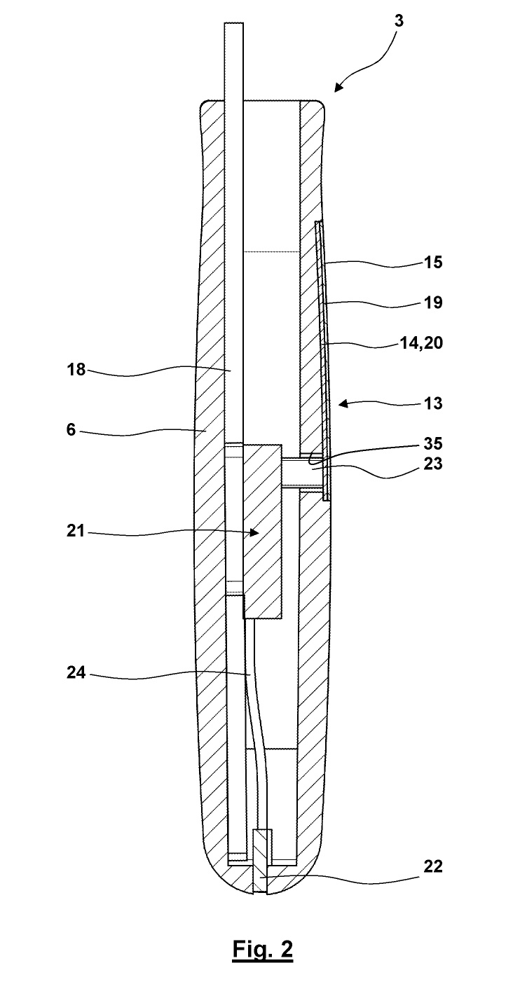

FIG. 2 shows a sectional view through the hand lever 3. The hand lever 3 comprises two plate-shaped struts 18 which are arranged distant from each other in the hand lever 3. In FIG. 2 only one strut 18 is shown. On the outer side the struts 18 are embedded into an elastomeric plastic material of the handle 6.

For the embodiment shown here, the display device 13 comprises a cover 19, a display 14 embodied as an electronic paper 20, a control unit 21 and a port 22 (here an USB port). The control unit 21 is connected via an electric cable 23 (preferably through a recess or bore 35 of the strut 18) to the electronic paper 20 and by another electric cable 24 to the port 22. For a generation or modification of a display of the electronic paper 20 the port 22 is connected by a cable to an external device. By the external device and the port 22 then on the one hand the electric power supply of the control unit 21 and the electronic paper 20 for the generation or modification of the display of the electronic paper 20 is provided. On the other hand by the external device and the port 22 a control signal is provided which contains the information for the intended hand tool identification to be displayed.

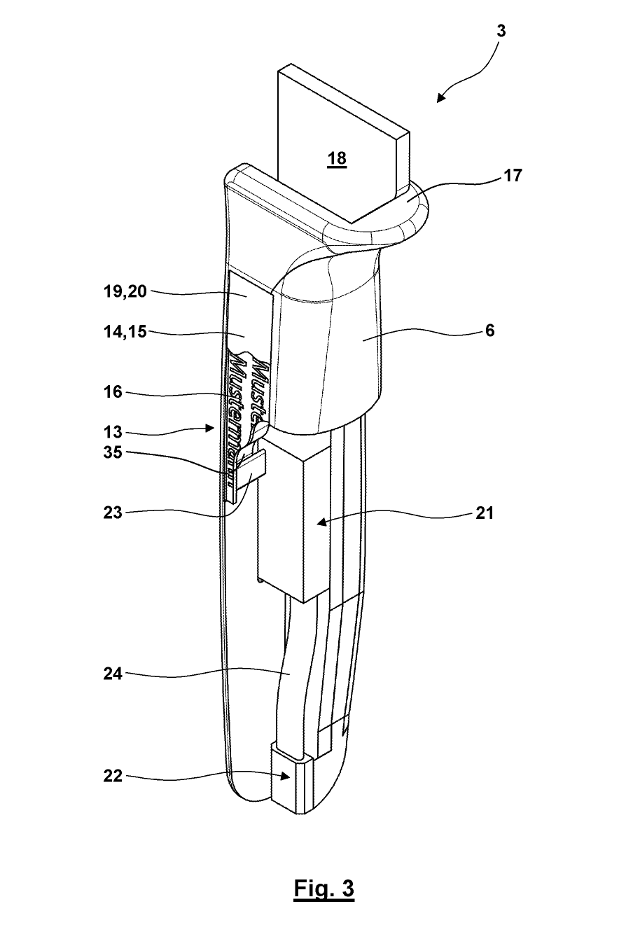

It is possible that the port 22 is embedded into the plastic material of the handle 6. Also the port 22 might be extrusion-coated by the plastic material. It is also possible that the port 22 is mounted to a strut 18. The cable 24 extends between the two struts 18 in the direction of the longitudinal axis of the hand lever 3. The control unit 21 is mounted to the strut 18. The electronic paper 20 and the cover 19 are also embedded into the outer surface of the handle 6. It is possible that the cover is releasably connected to the handle 6 (and to the electronic paper 20), e.g. by clipsing into the handle 6, screwing to the handle 6 or any other connection. However, it is also possible that the cover 19 is fixedly connected to the handle 6. Preferably, the cover also provides a sealing when using the pliers 1 in a wet environment. The cover 19 might also protect the electronic paper 20 arranged thereunder against mechanical impairments. The cable 23 extends preferably transverse to the longitudinal axis of the hand lever 3 between the control unit 21 and the electronic paper 20 through the recess 35. This can also be seen from the three-dimensional view according to FIG. 3.

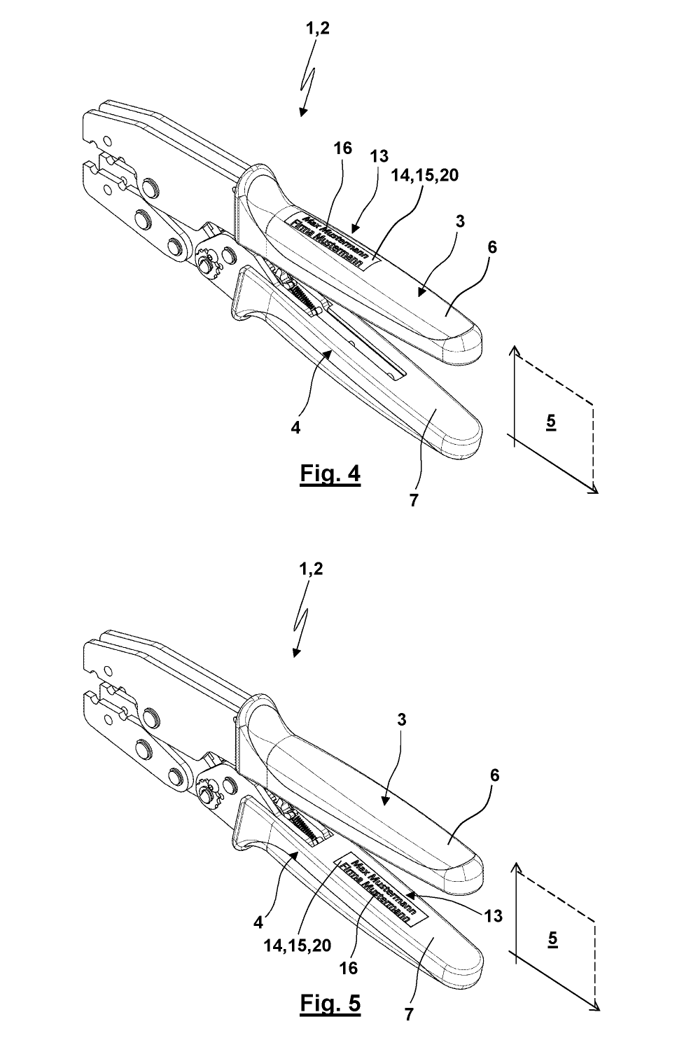

FIG. 4 shows an embodiment of the pliers 1. Here, the display area 15 of the display device 13 comprises a surface normal which is arranged in the pivot plane 5 and has an orientation vertical to the longitudinal axis of the hand lever 3. Accordingly, the display device 13 with its display area 15 is arranged on the outer side of the hand lever 3 facing away from the hand lever 4. Also here the display device 13 is embedded into the handle 6.

FIG. 5 shows an embodiment of pliers 1 wherein the surface normal of the display area 15 of the display device 13 is also arranged in the pivot plane 5 and arranged vertical to the longitudinal extension of the hand lever 4. However, here the display area 15 with the display device 13 is arranged on the inner side of the hand lever 4 facing towards the hand lever 3. The comparison of the FIGS. 4 and 5 shows that it is possible to arrange the display device 13 with the display area 15 at any longitudinal extension of a hand lever 3, 4.

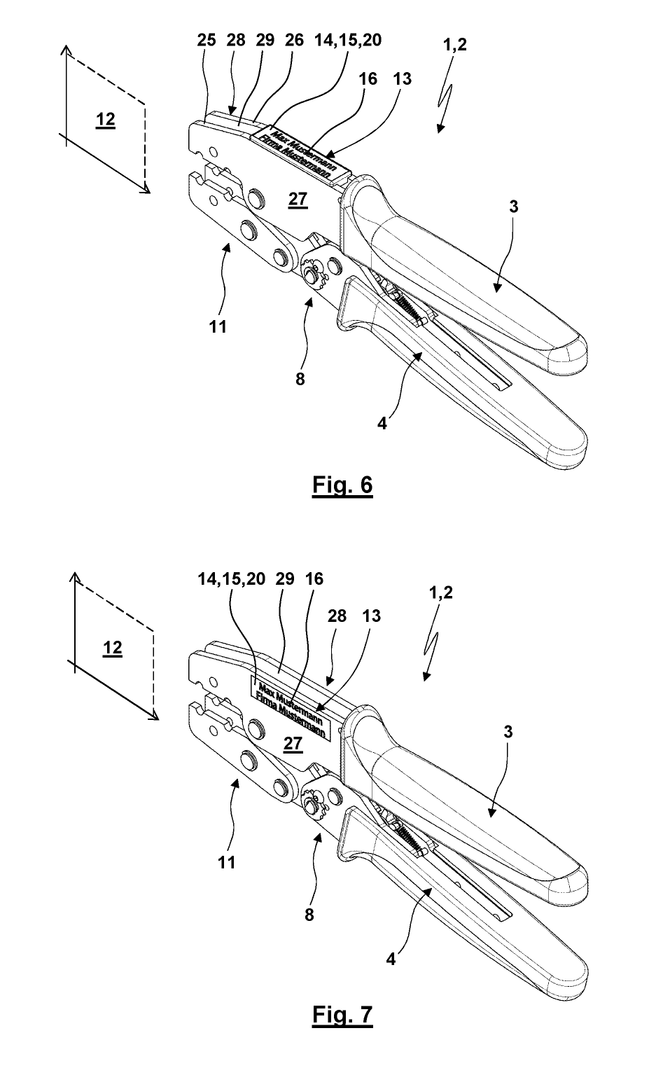

FIGS. 6 and 7 show embodiments of pliers 1 wherein the display device 13 is not arranged in the region of the hand levers 3, 4. Instead, here the display device 13 is arranged in the region of the pliers head 11. For the embodiment of FIG. 6, the display device 13 with its display area 15 is arranged on an upper side of the pliers 1. The surface normal of the display area 15 extends in the pliers head plane 12 and has an orientation vertical to the longitudinal axis of the pliers 2. The display device 13 is here supported at the front sides 25, 26 of cover plates 27, 28. It is possible that the display device 13 extends in an intermediate space 29 formed between the cover plates 27, 28.

For the embodiment of FIG. 7, the surface normal of the display area 15 extends vertical to the pliers head plane 12. The display area 15 is here arranged at the outer surface of the cover plates 27. For the shown embodiments, with the cover plates 27, 28 a here fixed pliers jaw 9 is formed. This is a resting pliers jaw 9 which together with the hand lever 3 forms a rigid component. Here, it is possible that the cover plates 27, 28 integrally form the two struts 18.

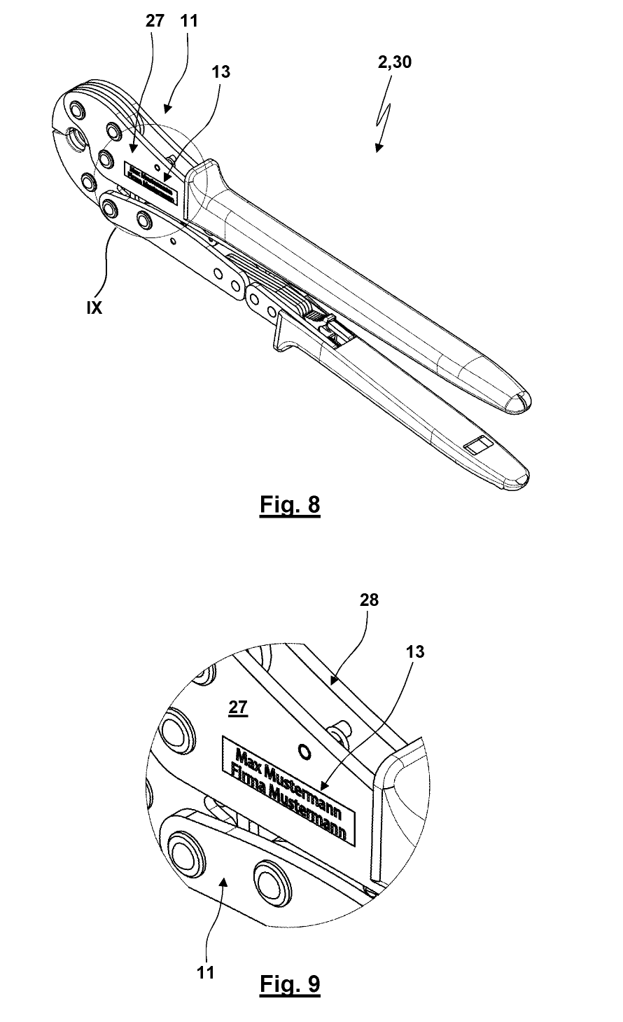

For the embodiment of FIGS. 8 and 9, the hand tool 2 is embodied as pressing pliers 30 for pressing tubes or fittings. Also here the display device 13 is arranged in the region of a pliers head 11, here in the region of a cover plate 27. With respect to options for the constructive design of pressing pliers 30 of this type, exemplary reference is made to the publications DE 199 24 086 C2 (corresponding to U.S. Pat. No. 6,286,358 B1), DE 199 24 087 C2 (corresponding to U.S. Pat. No. 6,289,712 B1), DE 199 63 097 C1 (corresponding to U.S. Pat. No. 6,474,130 B2), DE 103 46 241 B3 (corresponding to U.S. Pat. No. 7,155,954 B2), DE 10 2007 001 235 B4 (corresponding to U.S. Pat. No. 8,127,589 B2), EP 2 995 424 A1 (corresponding to U.S. Pat. No. 9,864,948 B2) of the applicant.

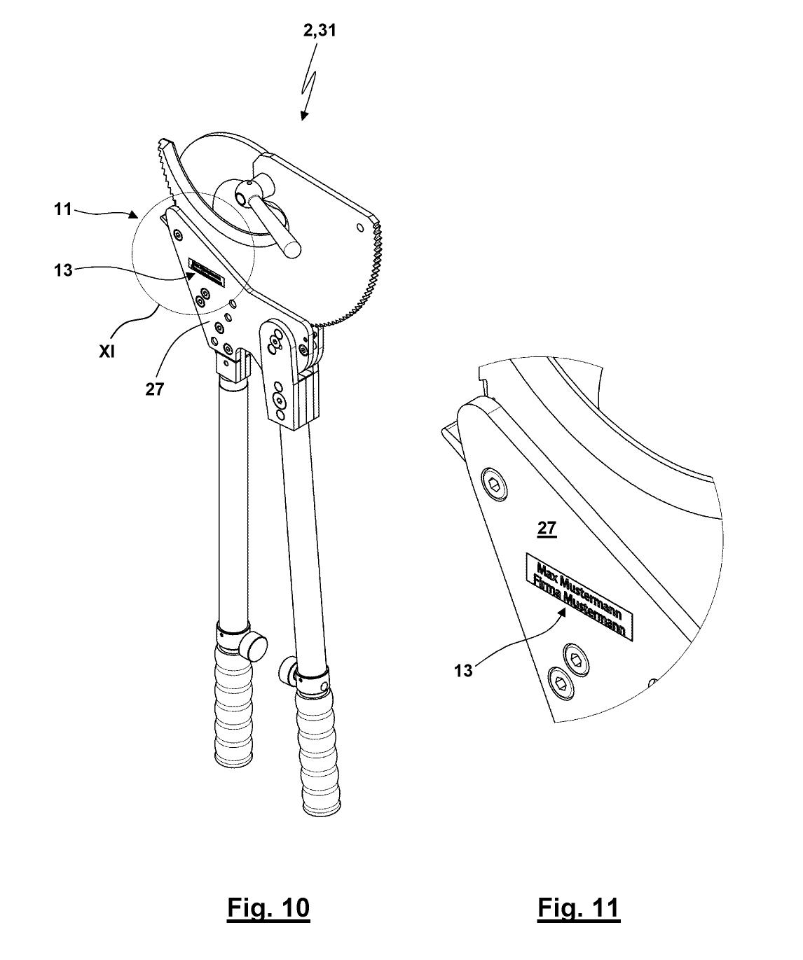

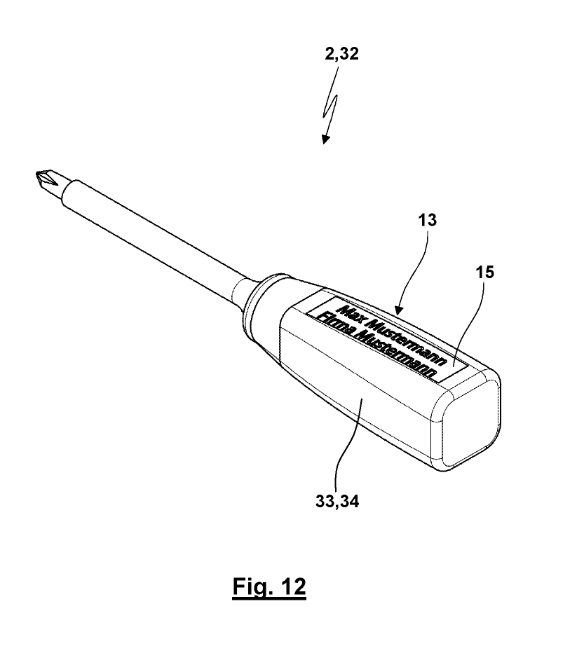

According to FIGS. 10 and 11, the hand tool 2 is embodied as cutting pliers 31 which are in particular designated for cutting of cables with large diameters or other strut-like or elongated workpieces. Also here the display device 13 is arranged in the region of a pliers head, here also in the region of a cover plate 27. With respect to the constructive design of cutting pliers 31, in particular reference is made to the publications DE 43 03 180 C1 (corresponding to U.S. Pat. No. 5,526,570 A), EP 3 159 088 A1 (corresponding to US 2017/0113367 A1), EP 3 159 107 A1 (corresponding to US 2017/0113358 A) of the applicant or current products with the label “Kabelschneider SH”.

Finally, FIG. 12 shows an embodiment of the hand tool 2 as screw driver 32. Here, the display device 13 is embedded into a handle 33 of the screw driver 32, for the shown embodiment in the region of the outer circumferential surface which here forms an actuation surface 34. A display area 15 of the display device 13 here extends in longitudinal direction in the region of the outer circumferential surface of the handle 33.

It is not intended that the use of the inventive display device 13 for a hand tool 2 is limited to the shown embodiments of hand tools 2. Instead, the invention might be used for any hand tool. In particular, the invention is used for a hand tool which is currently distributed by the applicant, cp. also the current catalogue “Werkzeuge für die professionelle Anwendung” of the applicant.

Many variations and modifications may be made to the preferred embodiments of the invention without departing substantially from the spirit and principles of the invention. All such modifications and variations are intended to be included herein within the scope of the present invention, as defined by the following claims.

I claim:

1. A manually actuated hand tool comprising an electrically modifiable display device, the display being designed and configured for permanently displaying a hand tool identification without an electric powering of the same.

2. The hand tool of claim 1, wherein the hand tool identification is at least one of
a) a user name,
b) a sequence of ciphers, a sequence of letters or a sequence of numbers which individualizes the hand tool,
c) a trademark of a manufacturer of the hand tool,
d) an identification of a type or configuration of the hand tool,
e) a running number of the hand tool or
f) a logo or a graphic.

3. The hand tool of claim 1, wherein the display device is arranged in a region of a manual actuating surface of the hand tool.

4. The hand tool of claim 1, wherein the hand tool is a screw driver.

5. The hand tool of claim 1, wherein the hand tool is embodied as pliers comprising two hand levers that can be pivoted relative to each other.

6. The hand tool of claim 5, wherein the display device is arranged in a region of
a) a hand lever or
b) a pliers head.

7. The hand tool of claim 6, wherein
a) a control unit,
b) an electric cable and/or
c) a port
are/is integrated into a hand lever.

8. The hand tool of claim 7, wherein
a) the control unit,
b) the electric cable and/or
c) the port
are/is arranged between two metallic struts of a hand lever.

9. The hand tool of claim 1, wherein the display device comprises a cover which protects the display device against mechanical biases and/or seals the display device.

10. The hand tool of claim 1, wherein a wireless receiving device is provided
for an external power supply and/or
for a control signal for generating or modifying a display of the display device.

11. The hand tool of claim 1, wherein an interface is provided
for a wired external power supply and/or
for a wired control signal for generating or modifying a display of the display device.
